(19) United States
(12) Patent Application Publication
(10) Pub. No.: US 2025/0273392 A1
(43) Pub. Date: Aug. 28, 2025

(54) Formation of Inductor Core Stacks Using Self-Assembled Monolayers

(71) Applicant: Applied Materials, Inc., Santa Clara, CA (US)

(72) Inventors: Marvin Louis BERNT, Whitefish, MT (US); Yi ZHENG, Sunnyvale, CA (US); Tapash CHAKRABORTY, Dombivali (IN); Prayudi LIANTO, Singapore (SG)

(21) Appl. No.: 18/590,169

(22) Filed: Feb. 28, 2024

(51) Int. Cl. H01F 41/02; H01F 27/24

(52) U.S. Cl. CPC H01F 41/0206; H01F 27/24

(57) ABSTRACT

A method for forming a multi-layer inductor core incorporates a leaky self-assembled monolayer (SAM) as a plateable dielectric layer that is interposed between magnetic layers formed by electrochemical deposition (ECD) plating processes. A method may include depositing a dielectric layer on a first magnetic layer of an inductor core stack where the dielectric layer is a SAM layer and depositing a second magnetic layer on the dielectric layer of the multi-layer inductor core. The method may be repeated to form as many layers as desired. Subsequent dielectric layers may be the same SAM layer or a different SAM layer. A mix of different molecules may be used in the SAM layers to form the dielectric layers.

### FIELD

Embodiments of the present principles generally relate to semiconductor processing of semiconductor substrates.

### BACKGROUND

Inductors are used in electronic devices to provide signal manipulation such as choking, blocking, or filtering of certain frequencies. Inductors can also be used in electrical circuits for power applications for storing and transferring energy, impedance matching, and tuning of LC circuits. Advancements in materials for inductor core use has helped to increase the inductor performance. The inventors have observed, however, that the processes produce low performance inductors and are often costly and time consuming, reducing the yield.

Accordingly, the inventors have provided methods for forming multi-layer inductor core stacks with increased performance and lower manufacturing costs.

### SUMMARY

Methods for forming multi-layer inductor core stacks with self-assembled monolayer dielectrics are provided herein.

In some embodiments, a method for forming a multi-layer inductor core may comprise depositing a first dielectric layer on a first magnetic layer of the multi-layer inductor core where the first dielectric layer is a first self-assembled monolayer (SAM) layer and depositing a second magnetic layer of the multi-layer inductor core on the first dielectric layer.

In some embodiments, the method may further include a second magnetic layer that is deposited on the first dielectric layer using an electrochemical deposition (ECD) process, an in situ magnetic alignment process that is performed on the multi-layer inductor core, depositing of the first magnetic layer and the first dielectric layer in a single chamber, a first SAM layer that is deposited using a spray process, an aerosol process, or a dip process, an annealing process that is performed in situ at a temperature of approximately 100 degrees Celsius to approximately 200 degrees Celsius after depositing of the first dielectric layer, a first SAM layer that is deposited using a vapor phase deposition process, a liquid phase deposition process, or a microcontact printing process, a first SAM layer that has a head group attached to the first magnetic layer, a tail group distal to the first magnetic layer, and a carbon chain backbone with a length of C3 to C22, a first SAM layer that is a continuous and porous layer over the first magnetic layer that permits electron travel from the first magnetic layer through the first SAM layer, a first SAM layer that is formed with a tail group that attracts metal to form a metal seed layer, a first SAM layer that has mixed molecules, performing the depositions of the SAM layers and/or magnetic layers at a temperature of less than approximately 400 degrees Celsius, a first SAM layer that has a dielectric constant of approximately 2.0 to approximately 3.0 and a thickness of less than 5 nm, and/or depositing a second dielectric layer on the second magnetic layer where the second dielectric layer is a second SAM layer and depositing a third magnetic layer on the second dielectric layer.

In some embodiments, an inductor core may comprise a first magnetic layer of an inductor core stack of the inductor core, a dielectric layer of the inductor core stack formed directly on the first magnetic layer where the dielectric layer is a self-assembled monolayer (SAM) layer, and a second magnetic layer of the inductor core stack formed directly on the dielectric layer.

In some embodiments, the inductor core may further include a SAM layer that has a head group attached to the first magnetic layer, a tail group distal to the first magnetic layer that is attached to the second magnetic layer, and a carbon chain backbone with a length of C3 to C22, a SAM layer that has a dielectric constant of approximately 2.0 to approximately 3.0 and a thickness of less than 5 nm, a SAM layer that has mixed molecules, and/or a second dielectric layer of the inductor core stack formed directly on the second magnetic layer where the second dielectric layer is a second SAM layer and a third magnetic layer of the inductor core stack formed directly on the second dielectric layer.

In some embodiments, a non-transitory, computer readable medium having instructions stored thereon that, when executed, cause a method for forming a multi-layer inductor core to be performed where the method may comprise depositing a dielectric layer on a first magnetic layer of the multi-layer inductor core where the dielectric layer is a self-assembled monolayer (SAM) layer and depositing a second magnetic layer on the dielectric layer to form the multi-layer inductor core.

Other and further embodiments are disclosed below.

### BRIEF DESCRIPTION OF THE DRAWINGS

Embodiments of the present principles, briefly summarized above and discussed in greater detail below, can be understood by reference to the illustrative embodiments of the principles depicted in the appended drawings. However, the appended drawings illustrate only typical embodiments of the principles and are thus not to be considered limiting of scope, for the principles may admit to other equally effective embodiments.

FIG. 1 is a method for forming multi-layer inductor core stacks with self-assembled monolayer dielectrics in accordance with some embodiments of the present principles.

FIG. 2 depicts cross-sectional views of a multi-layer inductor core stack in accordance with some embodiments of the present principles.

FIG. 3 depicts cross-sectional views of chambers for producing multi-layer inductor core stacks in accordance with some embodiments of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The methods provide multi-layer inductor core stacks with increased performance and lower manufacturing costs. A stack of alternating layers of dielectric and metal alloy layers are used to form a magnetic core of an inductor. The metal alloy layers are formed using electrochemical deposition (ECD) processes and the dielectric layers are formed using self-assembled monolayers (SAMs). The magnetic cores produced using the present method can be optimized to enhance electrical and magnetic performance of an inductor. The techniques have additional benefits in that the cost of the dielectric deposition is very low and can be performed in a simple chamber or in situ in the metal alloy deposition chamber. Control of the dielectric thickness is tunable and the dielectric material parameters are also adjustable.

Traditional processes for forming single magnetic layer cores use physical vapor deposition (PVD) or ECD processes to deposit the single layer. However, multi-layer magnetic cores are typically preferred over single magnetic layer cores for better performance figure of merit (FOM). In some instances, a stacked magnetic and dielectric core is formed using a multi-chamber process involving PVD deposition techniques where the magnetic layer is formed by sputtering of a target. The dielectric layer is then formed by sputtering dielectrics onto the magnetic layer or by sputtering metal in an oxygenated or nitrogenated environment onto the magnetic layer. The inventors have found that the PVD processes are expensive and performance, such as, for example, the Q factor and efficiency, are not sufficient for high frequency and high current applications. Other manufacturing techniques have produced cores using ECD plating for both the dielectric layer and the magnetic layer and using ECD deposition of polymer dielectric layers on ECD plated magnetic layers.

SAMs have advantages over polymers as dielectric layers for inductor core stacks of the present techniques. SAMs of organic molecules are molecular assemblies formed spontaneously on surfaces by adsorption and are organized into large, ordered domains. The present methods are directed to using short (C3) to long chain (C22) organic molecules to form SAMs and may include small organic rings inside. Although polymers can also form self-assembled layers, SAMs outperform polymers in that SAMs can be made less than 5 nm in thickness whereas polymers have thicknesses of greater than 5 nm. In addition, polymers such as, for example, polypyrrole (PPy) are difficult to process due to solubility issues which do not occur with SAMs.

In the present method, magnetic core stacks can be formed using alternate deposition of dielectric layers by a SAM process onto magnetic layers. The dielectric material can be easily and cost-effectively changed layer-by-layer and/or by device type. The dielectric layer thickness can be altered by adjusting the material and/or the deposition process. SAM deposited dielectric layers achieve sufficient electrical isolation to reduce eddy currents but have sufficient conductivity or leakiness to allow plating subsequent magnetic layers. The present techniques allow formation of a multi-layer core stack at a lower cost than by alternating magnetic and dielectric layers using PVD deposition processes while reducing eddy current generation compared to a single thick magnetic layer. The present principles also have the flexibility for engineered dielectric layers by immersion, spray, and/or vapor deposition processes. The processes have the capability to add the dielectric selectively in targeted magnetic areas and/or to deposit globally and remove from non-target areas once the stack is complete.

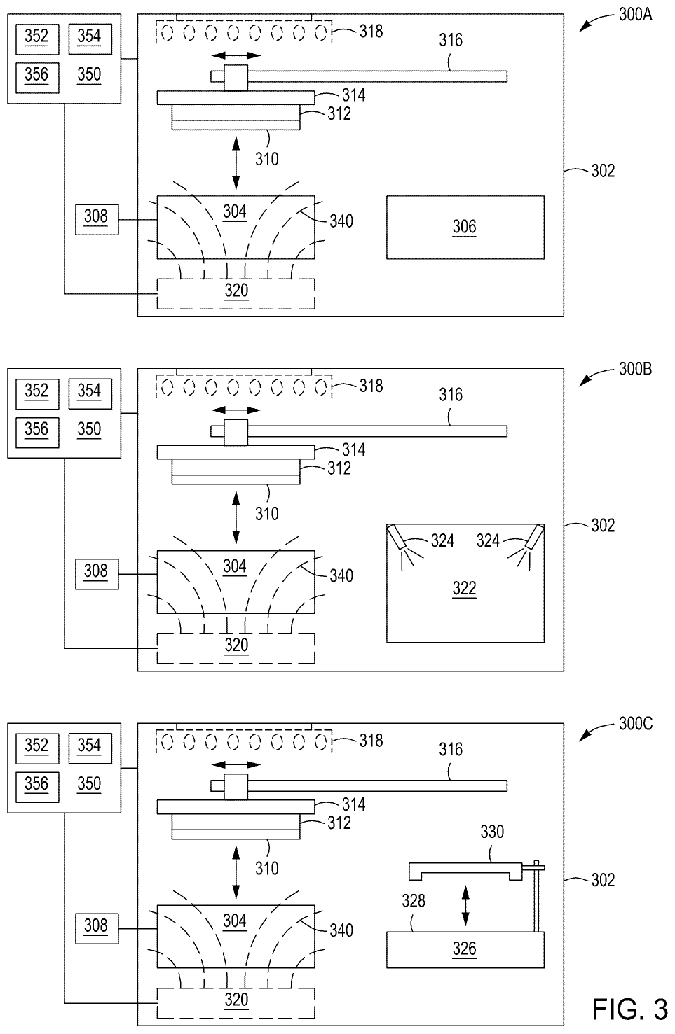

In brief, in some embodiments, the methods start by depositing a barrier and seed metal deposition. The magnetic layer is then electroplated onto the seed metal in a first chamber. The dielectric layer (SAM layer) is then deposited globally over the substrate using a non-selective deposition using the same chamber as the first chamber (see, e.g., FIG. 3) or a different second chamber. In some embodiments, with long SAM deposition processes, substrates can be gathered after plating of the magnetic layers for batch processing in, for example but not limited to, an immersion chamber for dielectric deposition for improved throughput. A second magnetic layer is then plated over the dielectric layer. A second dielectric layer is then deposited globally over the second magnetic layer. The SAM layer of the second dielectric layer may be altered over the first dielectric layer in material type or thickness. The variations may be accomplished by altering deposition parameters or aqueous liquid material delivery (e.g., using a manifold). The method can be repeated for the number of layers desired in the inductor core stack. In some embodiments, the SAM layers may be annealed to treat the SAM layers before deposition of the next magnetic layer to aid in speeding up the process of reorganizing the SAM layer after deposition of the SAM layer. More details of a method of the present principles follows.

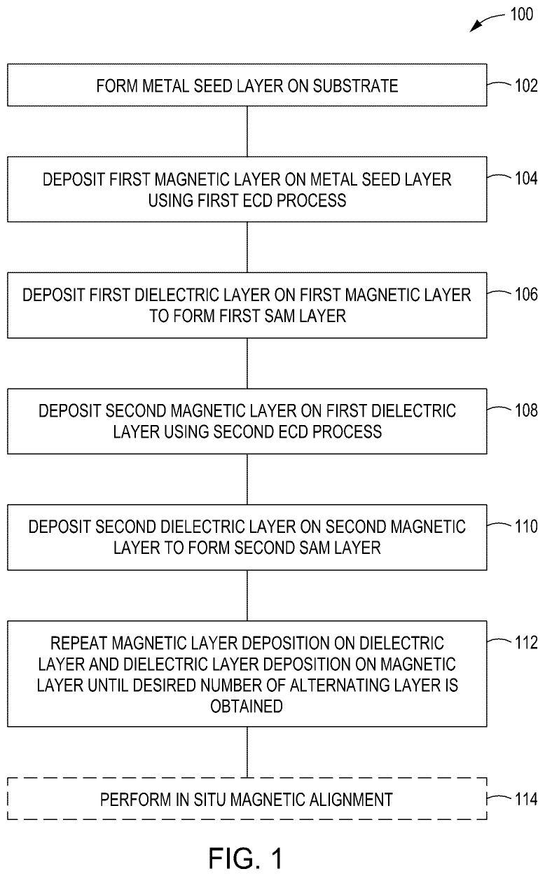

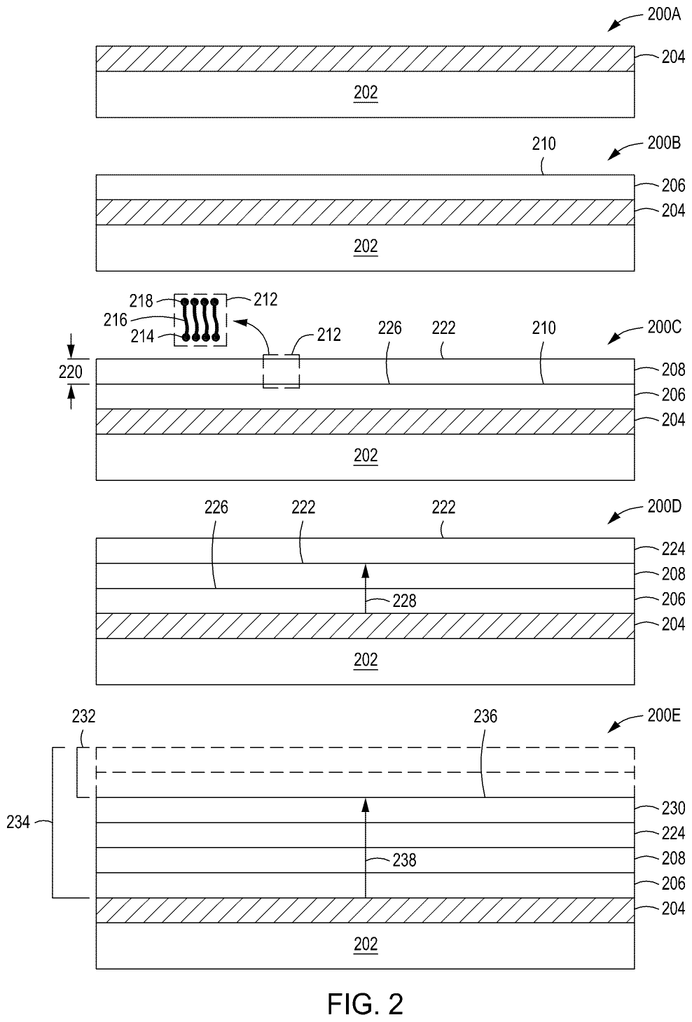

FIG. 1 is a method 100 for forming multi-layer inductor core stacks with self-assembled monolayer dielectrics. The multi-layer inductor core stack uses SAM layers interposed between magnetic layers. References to FIG. 2 are made in the discussion of the method 100. In block 102, a metal seed layer 204 is formed on a substrate 202 as depicted in a view 200A of FIG. 2. The metal seed layer 204 facilitates in the plating processes used for forming magnetic layers of the multi-layer inductor core. In block 104, a first magnetic layer 206 is deposited on the metal seed layer 204 using a first ECD process as depicted in a view 200B of FIG. 2. The magnetic layers may be formed of a material such as, but not limited to, a cobalt-based material, an iron-based material, and/or a nickel-based material, in which the materials may also contain alloyed elements such as boron, tantalum, and/or silicon, and the like for desired microstructures and composition. In some embodiments, the plating is performed by submerging the substrate 202 into a plating bath and flowing current into the substrate 202 at a connection to the metal seed layer 204. The inventors have found that electrochemical deposition produces substantially higher performing magnetic films than electroless deposition.

In block 106, a first dielectric layer 208 is deposited on the first magnetic layer 206 using a first SAM process to form a first SAM layer as depicted in a view 200C of FIG. 2. The first dielectric layer 208 is a SAM layer with a head group 214 that has an affinity towards the metal surface 210 of the first magnetic layer 206 (see, e.g., section 212 of the first dielectric layer 208 of view 200C of FIG. 2). The backbone 216 of the SAM layer is a carbon chain. The tail group 218 of the SAM layer is positioned distal to the metal surface 210 of the first magnetic layer 206. The SAM layers can disrupt the buildup of eddy currents within the magnetic layers of the inductor core and have a thickness 220 that is thin (but highly resistive) enough to minimally impact the overall magnetic layer content of the inductor core. In the present methods, the SAM layers allow vertical transfer of current such that exposed surfaces of the SAM layers are plateable.

The SAM layers are formed as a continuous layer on the magnetic layers but with a porosity such that the SAM layers are ‘leaky’ on a localized, microscopic level. The porosity is caused by holes or defects within the SAM layer. The term ‘leaky’ as used herein denotes a SAM layer that allows sufficient electron flow (conductivity) between the top surface 222 of the SAM layer and the bottom surface 226 of the SAM layer to promote plating of the top surface 222 of the SAM layer with a second magnetic layer 224 (see view 200D of FIG. 2). During plating (ECD process), electrons will flow between the metal seed layer 204 and the top surface 222 of the first dielectric layer 208 (SAM layer) and through the first magnetic layer 206. In some embodiments, the electroplated film on the leaky SAM layer starts as a matrix of discontinuous nucleation sites that coalesce into a continuous film as plating progresses. In some embodiments, the leaky SAM layers may be formed with a limited conductivity (e.g., by chemical composition, thickness, etc.) such that the SAM layers are resistive enough to inhibit eddy current formation within the magnetic layers in the inductor core stack and provide sufficient barrier properties between magnetic layers but conductive enough to allow plating of magnetic layers to the SAM layers. The conductivity of the SAM layers does not need to rise to the level of allowing lateral current flow through the SAM layers, only enough conductivity to allow current flow vertically from the metal seed layer to the top surface of an exposed SAM layer. In some embodiments, characteristics of both types of leakiness (porosity and conductivity) may be present in the SAM layers.

In block 108, the second magnetic layer 224 is deposited on the first dielectric layer 208 using a second EDC process as depicted in a view 200D of FIG. 2. In some embodiments, the second EDC process may be different from the first EDC process. In some embodiments, the second ECD process may be the same as the first ECD process. As discussed above, the first dielectric layer 208 is a leaky SAM layer that allows current flow 228 (current flow 228 may be positive or negative current) from the metal seed layer 204 to the top surface 222 of the first dielectric layer 208 to allow plating of the second magnetic layer 224 on the first dielectric layer 208. In block 110, a second dielectric layer 230 is deposited on the second magnetic layer 224 using a second SAM process to form a second SAM layer as depicted in a view 200E of FIG. 2. In some embodiments, the second SAM layer formed by the second SAM process may be different from first SAM layer formed by the first SAM process in that at least one parameter or a portion of the process is altered. In some embodiments, the second SAM layer formed from the second SAM process may be the same as the first SAM layer formed by the first SAM process. Parameters of the SAM processes are discussed in detail below. Altering of the SAM processes allows for flexibility in tuning of the SAM layers to allow for performance tuning of the inductor core stack and/or for enhancing plating performance by controlling the leakiness of the SAM layers (e.g., altering thickness, conductivity, porosity, etc. based on position of the SAM layers within the stack, etc.).

In block 112, the magnetic layer deposition on dielectric layers and dielectric layer deposition on magnetic layers can be repeated 232 until a desired number of alternating layers in the inductor core stack 234 is obtained as depicted in the view 200E of FIG. 2. To plate additional magnetic layers on the second dielectric layer 230, current flow 238 from the metal seed layer 204 travels to the top surface 236 of the second dielectric layer 230 as similarly described for the plating of the top surface 222 of the first dielectric layer 208. The method 100 can be performed any number of times. In some embodiments, the SAM layer processes can be altered for each dielectric layer of the inductor core stack 234. In some embodiments, the SAM layer processes may be identical for each dielectric layer of the inductor core stack 234. In some embodiments, the material used for the magnetic layers may be altered for each magnetic layer in the inductor core stack 234. In some embodiments, the material used for the magnetic layers may be the same for each magnetic layer in the inductor core stack 234.

In block 114, the inductor core stack 234 is optionally, magnetically aligned in situ. During formation of the inductor core stack 234, the magnetic layers may be magnetically aligned in the presence of a strong magnetic field as the magnetic layers are formed. Aligning the magnetic layers during plating creates a stronger magnet. In traditional processes, the alignment is performed ex situ in a process where the inductors are introduced into a furnace and heated to approximately 300 degrees Celsius while strong magnetic fields are propagated through the inductors. In the present techniques, the use of a single chamber for both formation of the inductor core stack and alignment drastically reduces the costs of alignment compared to standalone chambers, with one chamber for deposition and another chamber for alignment. In some embodiments, the inductor core stack 234 may also undergo further processing such as patterning, etching, dicing, and the like to prepare the inductor core stack 234 for packaging, etc.

Method 100 may be performed in separate chambers. For example, the deposition of the magnetic layers can be performed in a first chamber and the deposition of the dielectric layers can be performed in a second chamber. The inventors have found, however, that the formation of the inductor core stack 234 can be accomplished more efficiently, in both time and cost, and under better controlled circumstances when the deposition of both the magnetic layers and dielectric layers are performed in a single chamber or platform. In some embodiments, an inductor core stack chamber 302 may be used for deposition of magnetic layers and dielectric layers as depicted in a view 300A of FIG. 3. The inductor core stack chamber 302 is an example and is not meant to be limiting as other configurations may be employed to accomplish the present methods beyond the ones described herein and depicted in FIG. 3. In view 300A, the inductor core stack chamber 302 has a plating bath 304 connected to a plating power source 308 and a SAM layer bath 306. In the example, which is not meant to be limiting, a substrate 310 is carried by a substrate transfer assembly 314 with suspension arms 312 and a transfer rod 316. The substrate transfer assembly 314 has the capability to move the substrate 310 between the plating bath 304 and the SAM layer bath 306. The suspension arms 312 can lower the substrate 310 into either bath. By alternating baths for substrate submersion, alternating layers of dielectric layers and magnetic layers can be formed on the substrate 310 to create the inductor core stack 234. Multiple SAM layer baths may also be used to provide mixed SAM layers (discussed below).

In some embodiments, the inductor core stack chamber 302 may optionally include a magnetic field source 320 that provides a strong magnetic field 340 internal to the chamber. The inductor core stack chamber 302 may also optionally include a heat source 318 such as, but not limited to, heating lamps and/or resistive elements and the like that may be used to further assist in aligning the magnetic layers. During formation of the magnetic layers on the substrate 310, a strong magnetic field 340 is generated into the plating bath 304 by the magnetic field source 320 to align the magnetic layers of the inductor core stack 234 in situ. In some embodiments, the substrate 310 can be heated by the heat source 318, in situ, to further aid alignment of the magnetic layers after formation. In some embodiments, heat treatments may be performed on batches of inductor core stacks external to the inductor core stack chamber 302 in a heat treatment alignment chamber to further enhance the magnetic alignment of the magnetic layers.

As discussed below, the deposition of the dielectric layers can be performed using different processes. The inductor core stack chamber 302 of view 300A depicts a submersion bath process for the deposition of the SAM layers (dielectric layers). A view 300B of FIG. 3 depicts the inductor core stack chamber 302 with a SAM deposition area 322 with nozzles 324. In some embodiments, the SAM deposition area 322 may be used to spray the SAM molecules in liquid form onto the substrate 310 to form SAM layers (dielectric layers). In some embodiments, the SAM deposition area 322 may be used to spray the SAM molecules in vapor form onto the substrate 310 to form SAM layers (dielectric layers). A view 300C of FIG. 3 depicts the inductor core stack chamber 302 with a SAM deposition area 322 with a microcontact printer 326. The microcontact printer 326 has a substrate support surface 328 on which the substrate 310 can be positioned for printing. A stamp 330 imprints the SAM layer directly onto the substrate 310.

In some embodiments, the variations of the above inductor core stack chamber 302 also includes a controller 350. The controller 350 controls the operation of any of the methods or processes described herein for the inductor core stack chamber 302. The controller 350 may use a direct control of the inductor core stack chamber 302, or alternatively, by controlling the computers (or controllers) associated with the inductor core stack chamber 302. In operation, the controller 350 enables data collection and feedback from the inductor core stack chamber 302 to optimize performance of the inductor core stack chamber 302 and to control the processing flow according to methods/processes described herein. The controller 350 generally includes a central processing unit (CPU) 352, a memory 354, and a support circuit 356. The CPU 352 may be any form of a general-purpose computer processor that can be used in an industrial setting. The support circuit 356 is conventionally coupled to the CPU 352 and may comprise a cache, clock circuits, input/output subsystems, power supplies, and the like. Software routines, such as methods as described herein may be stored in the memory 354 and, when executed by the CPU 352, transform the CPU 352 into a specific purpose computer (controller 350). The software routines may also be stored and/or executed by a second controller (not shown) that is located remotely from the inductor core stack chamber 302.

The memory 354 is in the form of computer-readable storage media that contains instructions, when executed by the CPU 352, to facilitate the operation of the semiconductor processes and equipment. The instructions in the memory 354 are in the form of a program product such as a program that implements methods of the present principles. The program code may conform to any one of a number of different programming languages. In one example, the disclosure may be implemented as a program product stored on a computer-readable storage media for use with a computer system. The program(s) of the program product define functions of the aspects (including the methods and processes described herein). Illustrative computer-readable storage media include, but are not limited to: non-writable storage media (e.g., read-only memory devices within a computer such as CD-ROM disks readable by a CD-ROM drive, flash memory, ROM chips, or any type of solid-state non-volatile semiconductor memory) on which information is permanently stored; and writable storage media (e.g., floppy disks within a diskette drive or hard-disk drive or any type of solid-state random access semiconductor memory) on which alterable information is stored. Such computer-readable storage media, when carrying computer-readable instructions that direct the functions of the methods described herein, are aspects of the present principles.

SAMs can be grown on a magnetic layer (e.g., a cobalt, iron, and/or nickel-based magnetic layer, etc.) on top of which another magnetic layer (e.g., a cobalt, iron, and/or nickel-based magnetic layer, etc.) can be deposited through ECD, and the method can be repeated to form a stacked inductor core. The resistivity and/or barrier properties of the SAMs can be modulated using process parameters such as, but not limited to, growth temperature, duration, annealing temperature, chain length, and/or mixtures of precursors. In some embodiments, to achieve the desired leakiness and eddy current reduction, the SAM layers are formed with a dielectric permittivity of 2.1-3.0. SAMs in general are usually long chain organic (alkyl chain) molecules with an anchoring head group and a tail group at the other end and are grown from a very dilute solution of the organic molecules. SAMs can be grown at ambient temperatures or below (approximately 5 degrees Celsius to approximately 30 degrees Celsius) to grow crystalline structures or at slightly higher than ambient temperatures (e.g., approximately 40 degrees Celsius) to grow amorphous phase structures. Typical SAM growth can be divided into two stages—a fast anchoring stage (within a few minutes) and a slow reorganization process stage (takes hours to days) which makes the SAM more ordered, compact, and with fewer defects.

The stability of the SAMs improves with annealing after the initial deposition on the substrate. Annealing temperature depends on the type of SAMs. For example, less than 100 degrees Celsius is used for thiol SAMs (SAMs with —SH head groups) whereas more than 200 degrees Celsius is used for silane (—SiCl₃, —SiOR₃ head groups) and phosphonic acid (—PO₃H₂) SAMs. Annealing under an inert atmosphere is preferred to improve the stability of the SAMs. Increasing the backbone chain length of the organic molecule forming the SAM increases the SAM's stability, coverage, and barrier properties (e.g., a carbon C22 chain has more stability than a C3 chain). By using two or more types of organic molecules with various chain lengths, mixed SAMs can be used in the above methods and are more robust in barrier properties. For example, mixed SAMs with molecules having different chain lengths such as a percentage with C3 or C6 and the remaining percentage with C12 or C16 or C18 can be used. Organic molecules with two different functional groups at the molecule's two ends can bind to a substrate with one functional group and the other functional group can be used to bind to a different type of organic molecule again with two different functional groups in another subsequent process. The process can be repeated to get an organic multi-layer growth called Molecular Layer Deposition (MLD) similar to atomic layer deposition (ALD). An MLD process can be used to grow thicker layers. Different molecules can be used for each layer of the MLD by using a different bath (liquid phase submersion) for each layer. As an alternative process for forming SAM layers, in some embodiments, microcontact printing is a fast and economical way to grow SAMs using a silicone stamp such as a polydimethylsiloxane (PDMS) stamp.

Material selection for use in the present methods may include variations and/or combinations of the following for the SAM layer. Chemistry and process parameters may be altered to tune the inductor core stack performance and/or to enhance deposition on the SAM layers. Organic molecules with anchoring head groups such as, but not limited to, —SH, —SiCl₃, —Si(OR)₃, —P(O)(OH)₂, —COOH, —NH₂ may be used with similar polar functional groups such as, but not limited to, —SH, —SiCl₃, —Si(OR)₃, —P(O)(OH)₂, —CHO, —COOH, —NH₂ which may be chosen as the tail group (the tail group may be the same or different from the head group). In some embodiments, the carbon chain length of the SAM layer may be from C3 to C22. In some embodiments, the carbon chain length of the SAM layer may be C7 or C8. The inventors have found that if a carbon chain is too short, the SAM layer may not form a continuous layer over the magnetic layer (poor barrier properties). The SAM layer should be as thin (shorter carbon chain) as possible but still form a separate continuous layer over the magnetic layer. Longer carbon chains offer better barrier protection but take more time to assemble and produce unnecessarily thick SAM layers. The inventors have found that the thick SAM layers from the long carbon chains may not be sufficiently leaky and interfere with electroplating processes of subsequent magnetic layers. SAMs with hydrocarbon or fluorocarbon tails are hydrophobic (amphiphilic molecules) and are not suitable for growing a magnetic layer on top of the SAM layer unless the SAMs are made hydrophilic by chemical (e.g., oxidizing/hydroxylating) and/or plasma treatment. However, the treatments may damage and/or remove the SAM layer. Thus, SAMs with hydrocarbon or fluorocarbon tails are generally not used to form the inductor core stack due to the complexity, cost, and likelihood of damage to the SAM layer.

Organic molecules with anchoring head groups such as, but not limited to, —SH, —SiCl₃, —Si(OR)₃, —P(O)(OH)₂, —COOH, or —NH₂ used with —CHO as the tail group may be selected for forming a SAM layer with a carbon chain length from C3 to C22. The —CHO as a tail group can be used to form a silver film easily by silver mirror reaction using a solution of silver nitrate, ammonium hydroxide, and sodium hydroxide. The silver film can act as a seed layer for depositing a magnetic layer through an ECD process. However, lateral current flow through the silver film seed layer may not be sufficient for plating using the silver film seed layer connected to a plating current source. The silver film can be used to adjust the conductivity of the dielectric layer to enhance the plating process of the magnetic layers from the metal seed layer on the substrate in the above methods. SAMs with polar tail groups like —SH, —SiCl₃, —Si(OR)₃, —P(O)(OH)₂, —COOH, —NH₂, and —CHO are hydrophilic and suitable to deposit metal seeds like Cu, Ni, and Pd by electroless or autocatalytic process which may help to deposit the magnetic layer through an ECD process.

In some embodiments, to fine tune the SAM layer (dielectric layer), the SAMs can be grown from a very dilute solution of organic molecules (liquid phase). Growth temperature can be higher such as, but not limited to, approximately 40 degrees Celsius to approximately 50 degrees Celsius to make the SAM layer amorphous, resulting in increased resistivity. Liquid phase growth for SAMs is normally slower and annealing may be used after a short deposition duration in a liquid phase (e.g., up to approximately 15 minutes in duration) to hasten the reorganization process. Microcontact printing is another process option to apply the SAMs quickly (e.g., contact time may be approximately 5 minutes in duration) and is cost effective. Microcontact printing is normally used to make a pattern. However, in some embodiments, the present methods can incorporate the process for blanket deposition of SAMs on magnetic layers of the inductor core stack. SAMs may also be deposited in a vapor phase, by spraying, and/or using aerosols. In some embodiments, aerosol chemical vapor deposition (CVD) processes may not be suitable. Instead, after applying aerosol at room temperature, an annealing process may be used to reduce the reorganization time of the SAM layer. SAMs may also be deposited in a vapor phase while under vacuum if high molecular weight organic molecules are used. Vapor phase processes are expensive compared to liquid phase and microcontact printing processes. In some embodiments using CZT material as the magnetic layer, the CZT material surface is etched first by Br-MeOH before depositing a SAM layer with —SH, —COOH, or —NH₂ head groups. In some embodiments, an oxygen plasma treatment or an NH₄F+H₂O₂ treatment can be used to make the CZT surface hydroxylated (—OH groups) before depositing a SAM layer with —SiCl₃, —Si(OR)₃, or —P(O)(OH)₂ head groups.

Embodiments in accordance with the present principles may be implemented in hardware, firmware, software, or any combination thereof. Embodiments may also be implemented as instructions stored using one or more computer readable media, which may be read and executed by one or more processors. A computer readable medium may include any mechanism for storing or transmitting information in a form readable by a machine (e.g., a computing platform or a “virtual machine” running on one or more computing platforms). For example, a computer readable medium may include any suitable form of volatile or non-volatile memory. In some embodiments, the computer readable media may include a non-transitory computer readable medium.

While the foregoing is directed to embodiments of the present principles, other and further embodiments of the principles may be devised without departing from the basic scope thereof.

1. A method for forming a multi-layer inductor core, comprising:
depositing a first dielectric layer on a first magnetic layer of the multi-layer inductor core, wherein the first dielectric layer is a first self-assembled monolayer (SAM) layer; and
depositing a second magnetic layer of the multi-layer inductor core on the first dielectric layer.

2. The method of claim 1, wherein the second magnetic layer is deposited on the first dielectric layer using an electrochemical deposition (ECD) process.

3. The method of claim 1, wherein an in situ magnetic alignment process is performed on the multi-layer inductor core.

4. The method of claim 1, wherein the depositing of the first magnetic layer and the first dielectric layer occurs in a single chamber.

5. The method of claim 1, wherein the first SAM layer is deposited using a spray process, an aerosol process, or a dip process.

6. The method of claim 1, wherein an annealing process is performed in situ at a temperature of approximately 100 degrees Celsius to approximately 200 degrees Celsius after depositing of the first dielectric layer.

7. The method of claim 1, wherein the first SAM layer is deposited using a vapor phase deposition process, a liquid phase deposition process, or a microcontact printing process.

8. The method of claim 1, wherein the first SAM layer has a head group attached to the first magnetic layer, a tail group distal to the first magnetic layer, and a carbon chain backbone with a length of C3 to C22.

9. The method of claim 1, wherein the first SAM layer is a continuous and porous layer over the first magnetic layer that permits electron travel from the first magnetic layer through the first SAM layer.

10. The method of claim 1, wherein the first SAM layer is formed with a tail group that attracts metal to form a metal seed layer.

11. The method of claim 1, wherein the first SAM layer has mixed molecules.

12. The method of claim 1, wherein the method is performed at a temperature of less than approximately 400 degrees Celsius.

13. The method of claim 1, wherein the first SAM layer has a dielectric constant of approximately 2.0 to approximately 3.0 and a thickness of less than 5 nm.

14. The method of claim 1, further comprising:
depositing a second dielectric layer on the second magnetic layer, wherein the second dielectric layer is a second SAM layer; and
depositing a third magnetic layer on the second dielectric layer.

15. An inductor core, comprising:
a first magnetic layer of an inductor core stack of the inductor core;
a dielectric layer of the inductor core stack formed directly on the first magnetic layer, wherein the dielectric layer is a self-assembled monolayer (SAM) layer; and
a second magnetic layer of the inductor core stack formed directly on the dielectric layer.

16. The inductor core of claim 15, wherein the SAM layer has a head group attached to the first magnetic layer, a tail group distal to the first magnetic layer that is attached to the second magnetic layer, and a carbon chain backbone with a length of C3 to C22.

17. The inductor core of claim 15, wherein the SAM layer has a dielectric constant of approximately 2.0 to approximately 3.0 and a thickness of less than 5 nm.

18. The inductor core of claim 15, wherein the SAM layer has mixed molecules.

19. The inductor core of claim 15, further comprising:
a second dielectric layer of the inductor core stack formed directly on the second magnetic layer, wherein the second dielectric layer is a second SAM layer; and
a third magnetic layer of the inductor core stack formed directly on the second dielectric layer.

20. A non-transitory, computer readable medium having instructions stored thereon that, when executed, cause a method for forming a multi-layer inductor core to be performed, the method comprising:
depositing a dielectric layer on a first magnetic layer of the multi-layer inductor core, wherein the dielectric layer is a self-assembled monolayer (SAM) layer; and
depositing a second magnetic layer on the dielectric layer to form the multi-layer inductor core.
